(19) United States
(12) Patent Application Publication
(10) Pub. No.: US 2022/0383409 A1
(43) Pub. Date: Dec. 1, 2022

(54) METHOD AND SYSTEM FOR IDENTIFYING AUTOMOBILE LOANS

(71) Applicant: Tommy Vullo, Clarence Center, NY (US)

(72) Inventor: Tommy Vullo, Clarence Center, NY (US)

(21) Appl. No.: 17/752,447

(22) Filed: May 24, 2022

Related U.S. Application Data
(60) Provisional application No. 63/192,833, filed on May 25, 2021.

(51) Int. Cl. G06Q 40/02

(52) U.S. Cl. CPC G06Q 40/025

(57) ABSTRACT

A method and system for identifying automobile loans that are tailored to an individual customer based on the vehicle of interest and that person's economic circumstances at the time of the loan. Information is provided to the system, which then analyzes the information and provides the most suitable loans for the customer. The method and system works by using soft credit pulls and avoiding hard credit pulls until the correct loan is identified.

### CROSS-REFERENCE TO RELATED APPLICATIONS

This application claims priority to U.S. Provisional Application having Ser. No. 63/192,833, filed on May 25, 2021, the entire disclosure of which is hereby incorporated herein by reference.

### FIELD OF INVENTION

This invention is directed to a method and system for assisting automobile dealerships to match consumers with automobile loans. In particular, the system helps identify the most suitable automobile loan for a consumer.

### BACKGROUND OF INVENTION

When a consumer is looking to secure funding for the purchase of an automobile, the automobile dealership will send the consumer's information to every lender that the dealership works with. This does not always result in the best loan for the consumer and it also works damage on the consumer's credit report because the inquiries are often hard credit pulls, which means that they stay on the consumer's credit report for up to two years.

What is needed is a method and system for identifying the best lender and loan for the consumer under their particular circumstances. Additionally, it would be beneficial if the method and system could rely on soft credit pulls instead of hard credit pulls. This would result in less of a negative impact on the consumer's credit report.

### SUMMARY OF THE INVENTION

Accordingly, it is the subject of this invention to provide a method and system for identifying the best lender and loan for a consumer when purchasing an automobile.

In one embodiment, a computer-generated method includes the following steps: receiving, by a database, user input that includes customer data and vehicle data from a device, wherein the database includes lender data including at least one customized lending table for each lender; responsive to receiving vehicle data from the database, a server initiates vehicle logic to request vehicle value from an auto API; generating, by the server, a record or data point that includes the vehicle value; responsive to receiving customer data from the database, the server initiates credit logic to request credit information from a credit API; generating, by the server, a record or data point that includes credit information or pre-qualification information; responsive to receiving lender data from the database, the server initiates offer logic to generate loan offers; generating, by the server, in a database a record of loan offers, the record comprising data containing APR and monthly payment of the automobile loan offer, the database comprising non-transitory machine-readable storage media storing one or more records of one or more automobile loan offers; and presenting, by the server or database, for display on the device.

### BRIEF DESCRIPTION OF THE DRAWINGS

FIG. 1 depicts a system of the present invention.

FIG. 2 depicts a wire frame of a method of the present invention.

FIG. 3 depicts the architecture of a system of the present invention.

FIG. 4 depicts a flow chart for user interface and back end interface of a system of the present invention.

FIG. 5 depicts a flow chart for back end interface of a system of the present invention.

### DETAILED DESCRIPTION OF THE INVENTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

The systems and methods described herein use a model for identifying the most cost-effective or efficient automobile loan.

Unlike conventional methods, the model can account for the risk of the automobile loan. The system and method can provide information about the best or most suitable lender for a particular transaction. The results include the lender's name, location of lender, preferred contact, backend policies, terms of the loan (including monthly payment), and any available special programs for financing. The system generates a report that allows for auditing on each transaction to ensure lending standard compliance. The system and method provide an affordability test, meaning that the system ensures that an individual buys an automobile that is within that individual's budget and is thus affordable to the individual.

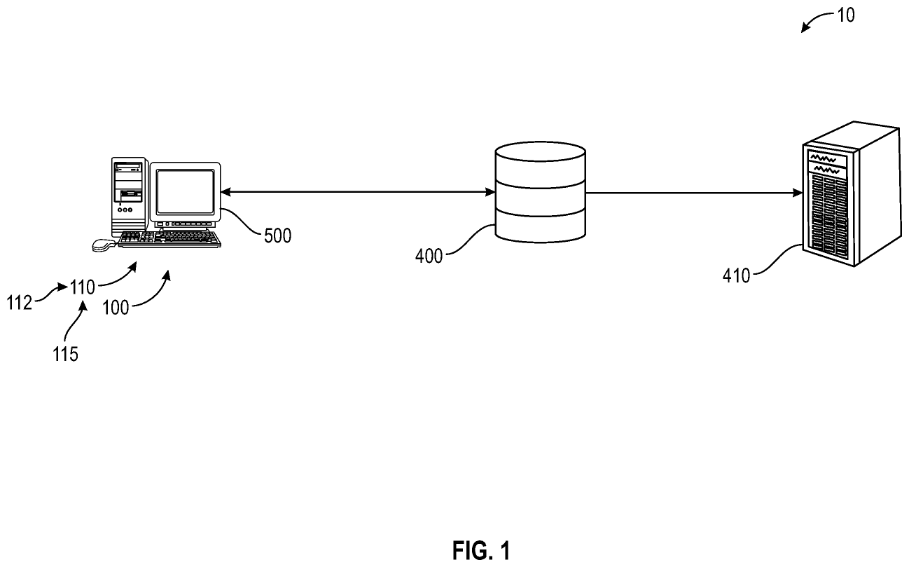

Referring to FIG. 1, a system overview 10 is shown. An automobile loan (AL) database 400, optionally, in combination with an automobile loan (AL) server 410 can calculate different automobile loans using lender data 100 which is input into AL database 400 and user input 110 which is input into AL database 400 from a user (not shown). The AL database 400 or AL server 410 can perform this calculation on a real-time or periodic (e.g., daily) basis. The calculations can be based upon a model that can be reset each time the AL database 400 or AL server 410 receives new data. The lender data 100 and the user input 110 can come from user input, bank or lender input, a combination of the two, or any suitable input. The lender data 100 and the user input 110 can come from different sources or the same source. The lender data 100 and the user input 110 can be transmitted to the AL database 400 or the AL server 410 on a real-time or periodic basis. Further, the model used by the AL database 400 or the AL server 410 can receive the lender data 100 and the user input 110 and use the data in that form, or the AL database 400 or AL server 410 can derive values from the lender data 100 and user input 110 for use in the model.

It is noted that in some embodiments, both an AL database 400 and an AL server 410 are required. In this embodiment, AL server 410 includes a CPU. In other embodiments, the AL database 400 contains a server and a CPU and, in this case, a separate standalone AL server is not required. In preferred embodiments, AL database 400 may be in the cloud.

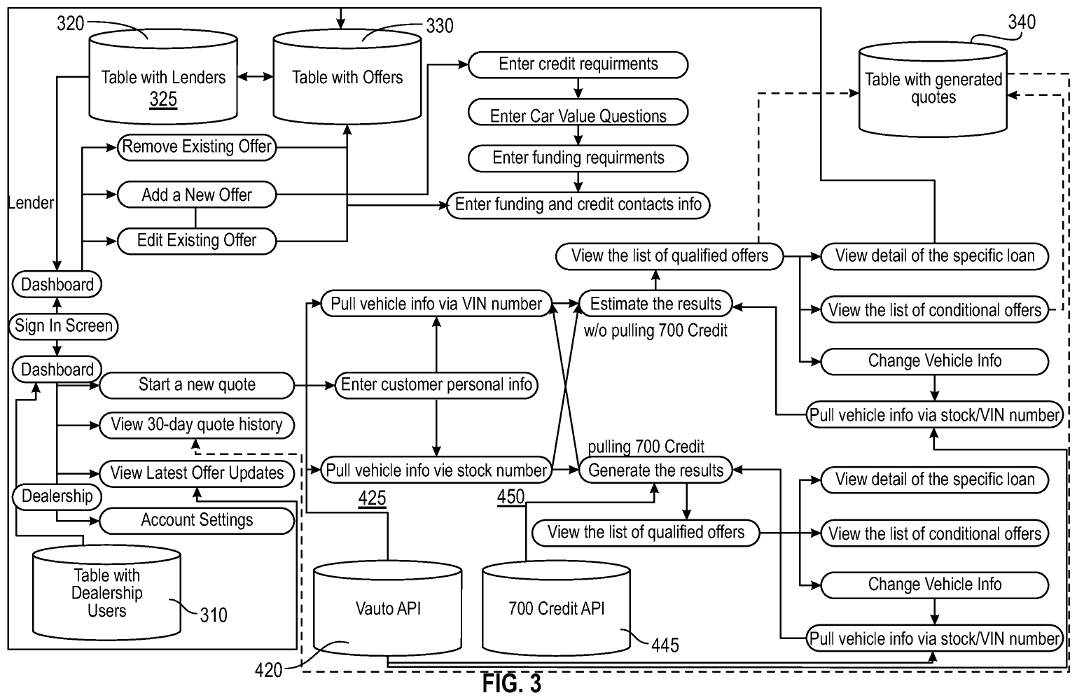

The lender data 100 can include specific information about the lender. It will also include (in the form of customized lending tables 325, see FIG. 3) any parameters that an automobile loan lender uses to determine whether they will offer an automobile loan. These parameters include, but are not limited to, credit score and history, income, expenses, liquid assets, time at current job, employment history, address history, debt to income ratio, payment to income ratio, loan to value, and down payment. Credit history may include delinquent accounts, unpaid collection accounts, past bankruptcy, foreclosures, number of recent applications for credit, and outstanding debts.

The user input 110 includes customer data 112 and vehicle data 115. Customer data 112 includes name, address, income, credit condition, trade lines, and the customer's credit score, time since bankruptcy, time at current job and any other information that is used to assess creditworthiness. Vehicle data 115 includes the make and model of the automobile to be financed, mileage, and vehicle identification number (VIN), vehicle sales prices, and the loan amount and term request. The user input 110 can be in a variety of forms, including a spreadsheet format.

The AL database 400 can transmit the loan information back to the user, such as an automobile dealer, by way of device 500. Alternatively, the AL database 400 can transmit the user input to an AL server 410 to execute a transaction based upon the calculation and received information. The AL database 400 and the AL server 410 can be located at an automobile dealer or at a financial institution or may be located at any suitable physical location or may be in the cloud. As mentioned above, the AL database 400 and the AL server 410 can be separate components or a single component that includes the functionality of the two separate components.

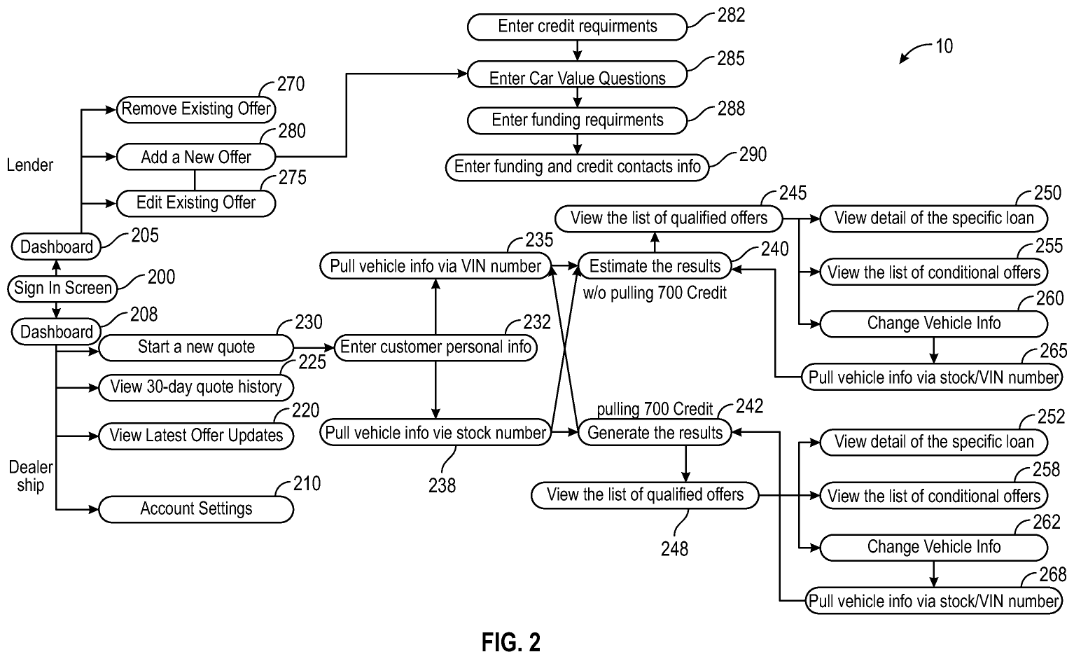

Referring to FIG. 2, in an exemplary method for identifying automobiles loans, the automobile dealership or lender will access a sign in screen 200, which opens a lender dashboard 205 or a dealership dashboard 208. The dashboard will be different for the automobile and the lender. The automobile dealership will use the system more often as they need to input user input 110, in particular, customer data 112 every time an automobile loan is required. As can be imagined, the automobile dealership can input vehicle data 115 as soon as new vehicles are acquired. In contrast, the lenders will access the dashboard when the parameters for extending an automobile loan change or when they have to create a new or update an existing order.

In the case of the automobile dealership, opening the dealership dashboard 208 will have the options of going to account settings 210, viewing the latest offer updates 220, viewing 30-day quote history 225, or starting a new quote 230. If the automobile dealership starts a new quote 230, then the next step is to enter customer personal info 232, the next step is to pull vehicle information, which can be done via the VIN number 235 or via the stock number 238. The next step will be to estimate the results of loan eligibility and this is done without pulling 700 credit (also referred to as a “hard pull” of the credit) 240 or with pulling 700 credit (“hard pull” of the credit) 242.

The next step is to view the list of qualified offers 245, 248. From there, the automobile dealership will be able to view details of the specific loan 250, 252, and view the list of conditional offers, 255, 258. If necessary, the automobile dealership might change the vehicle information 260, 262, which will require pulling the vehicle information via the stock or VIN number 265, 268. It is noted that steps 245, 250, 255, and 260, follow the step 240, which does not involve a 700 credit pull. Steps 248, 252, 258, and 262, follow the step 242, which does involve a 700 credit pull.

After steps 260 and 265, the method goes back to step 240 and repeats itself until a suitable loan can be found for the customer. Similarly, after steps 262 and 268, the method goes back to step 242 until a suitable loan can be found for the customer. It is noted that the steps 260, 265, 262, and 268, may not be required if a suitable loan is found for the customer at step 245, 248.

In the case of the lender, opening the dashboard will have the options of removing an existing offer 270, editing an existing offer 275, or adding a new offer 280. If the lender is adding a new offer 280, then the lender will enter credit requirements 282, enter car value questions 285, enter funding requirements 288, and enter funding and credit contact information 290.

FIG. 3 depicts an exemplary architecture behind the method shown in FIG. 2. Dealership table 310 is a table of dealership users that have access to the system 10. Dealership table 310 interacts with dealership dashboard 208. Lender table 320 includes a list of lenders that the automobile dealership works with. Lender table 320 interacts with the lender dashboard 205. Lender table 320 also interacts with offer table 330. Offer table 330 interacts with the method steps of removing an existing offer 270, editing an existing offer 275 and adding a new offer 280.

As can be seen both lender table 320 and offer table 330 also interact with the method step of view latest offer updates 220 within dealership dashboard 208. Offer table 330 also interacts with method step enter funding and credit contact info 290 and the method step of viewing the details of the specific loan 250, 252.

Quote table 340 includes a table with all of the generated quotes from the system 10. Quote table provides information to the method step of viewing 30-day quote history 225. Quote table 240 also receives information from the method step of viewing the list of qualified offers 245 and received information from the method step of viewing the list of conditional offers 255.

Dealership table 310, lender table 320, offer table 330, and quote table 340 are all located within AL database 400. The information contained in the tables may be static or may be updated from time to time as necessary.

Lender table 320 includes a list of all financial and lending institutions that the automobile dealership works with. Additionally, unique to this system, for each lending institution, there is at least one customized lending table 325 for that lending institution that includes parameters that that particular lending institution considers to be important in making decisions about whether to extend an automobile loan. This is discussed in further detail below.

FIG. 3 also depicts Auto API 350 and Credit API 360. Auto API 350 is any software program that is capable of providing a consistent data protocol for communication between cars and external 3rd party services. Auto API provides vehicle information to the method steps of pulling vehicle information via VIN number/stock number 235, 238, 265, 268. Credit API 360 is any software program that is capable of providing credit screening for automobile dealerships. Credit API 360 provides information and results to the method step of generating the results 242.

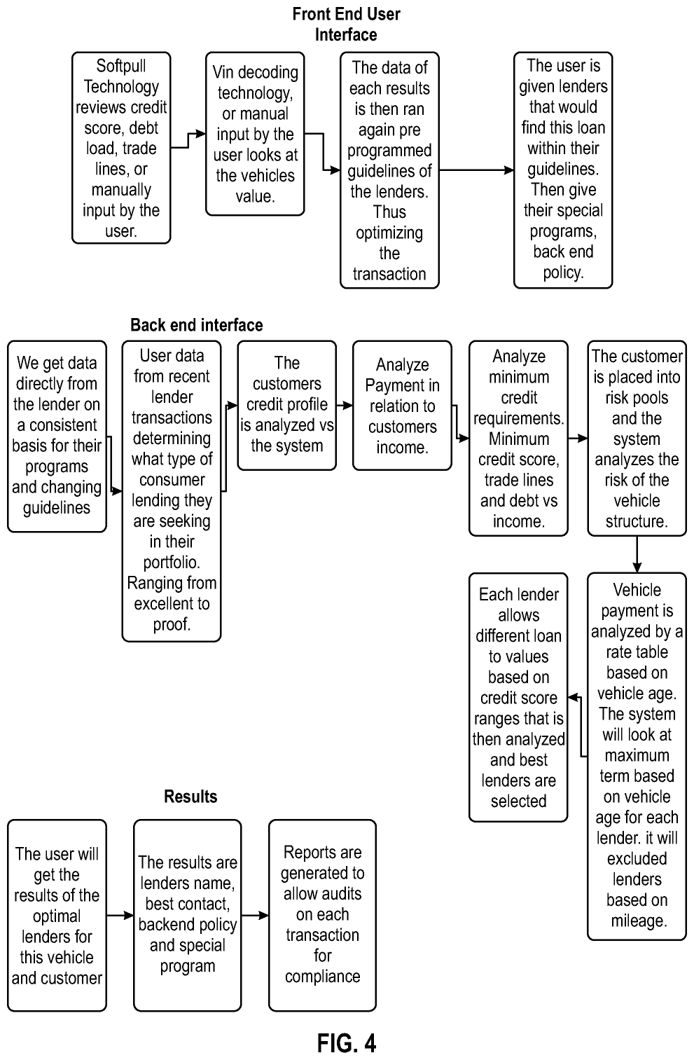

FIG. 4 depicts the front end user interface for one embodiment of the system. Initially, there is a soft pull of the applicant's credit, the system reviews the credit score, debt load, and trade lines. In an alternative embodiment, this information may be input manually. Next, the system requires input of the VIN either automatically or manually. The system will analyze the vehicle's value based on the VIN. The next step optimizes the transaction by running the applicant and VIN information against pre-programmed guidelines of the different lenders. Finally, the user is provided with a list of lenders that are willing to finance the loan within their guidelines. The system will also provide the applicant with any available special programs.

FIG. 4 also depicts the back end interface of one embodiment of the system. Lenders provide the system with information regarding their consistent basis lending variables and their programs and any variables that may change. The system also uses information and data regarding recent lender transactions in order to determine what type of consumer the lender is seeking in their portfolio. For example, the consumer may have credit ranging from excellent to poor and different lenders are looking to provide different levels of creditworthiness. The system then analyzes the applicant's credit profile, the applicant's monthly payment for the vehicle in relation to the applicant's income, the minimum credit requirements, credit score, trade lines, and debt to income ratio. The system will place the applicant in a risk pool and analyze the risk of the vehicle loan structure. Next the system will create a rate table based on the age of the vehicle. The system will also determine the risk of the vehicle loan. The system will analyze the vehicle payment by looking at a rate table based on the vehicle's age. The system will determine the maximum loan term based on the vehicle's age and depending on the loan amount. It will exclude lenders that are unwilling to finance a loan for vehicles above a certain mileage. Every lender allows different loan values depending on credit score ranges. With this information, the system determines the best lenders to select for the applicant purchasing a particular vehicle.

Next, the system provides the vehicle dealership with the information about the best lender for a particular transaction. The results include the lender's name, best contact, backend policies, and any available special programs for financing. The system generates a report that allows for auditing on each transaction to ensure lending standard compliance.

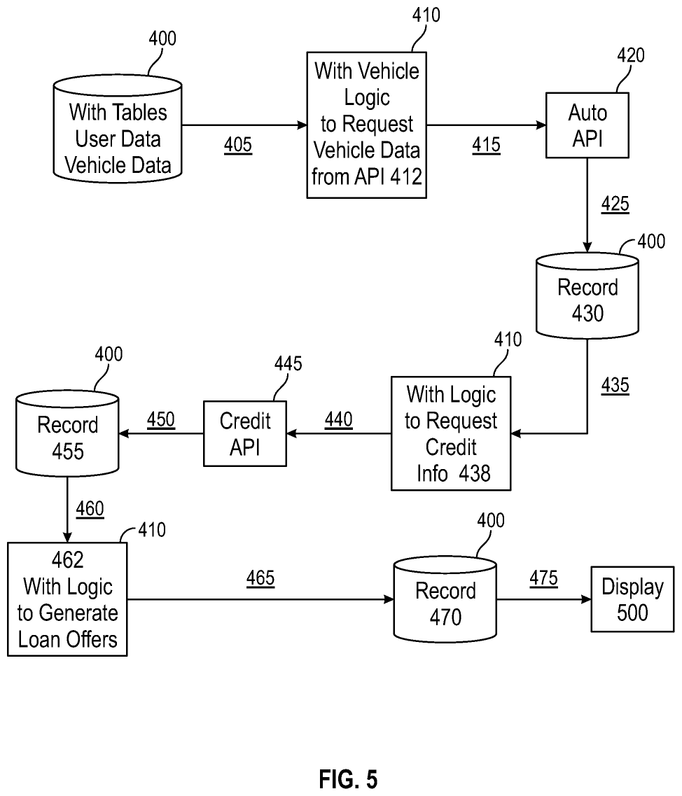

FIG. 5 depicts a flow chart of a system of the present invention. AL database 400 includes vehicle data 115 and relays 405 this information to AL server 410, wherein AL server 410 includes a CPU (not shown) and also includes vehicle logic 412 to request vehicle information. The AL server 410 runs vehicle logic 412 by way of step 415. Vehicle logic 412 communicates with auto API 420 to request 415 information regarding the vehicle's value based on the VIN number or the stock number of the vehicle. Auto API 420 obtains the information and communicates 425 this to AL database 400, which creates a vehicle value record 430. Vehicle value record may be a temporary data point that is used by the system 10, but not saved in AL database 400.

Next, AL database 400 relays 435 customer data 112 to AL server 410, which includes credit logic 438 to request credit information on the customer. The AL server 410 runs credit logic 438 by way of step 440. Credit logic 438 communicates with credit API 445 to request 440 the credit information for a customer. Credit API 445 obtains the information and communicates 450 this to AL database 400, which creates a credit record 455. Alternatively, the credit record 455 may be customer pre-qualification data or customer prequalification information and may exists as a temporary data point that isn't stored in the AL Database 400.

AL database 400 relays 460 the vehicle value record 430 (or vehicle value data point) and credit record 445 (or customer pre-qualification data point) to AL server 410, wherein AL server 410 contains offer logic 462 to generate loan offers. AL server 410 runs offer logic 462 by way of step 465. Offer logic 462 processes 465 the vehicle value record 430 (or vehicle value data point) and credit record 455 (or customer pre-qualification data point) in combination with the customized lending tables 325 in order to generate loan offers, which creates a loan offer record 470, which is stored in AL database 400. Loan offer record 470 is relayed to device 500 so that the dealership may view the list of qualified offers 245, 248, view the details of the specific loan 250, 252, or view the list of conditional offers 255, 258. The dealership may also view the 30-day quote history 225 or may view the latest offer updates 220. Using device 500, the lender may also see the loan offer record 470 and may remove an existing offer 270, add a new offer 280, or edit an existing offer 275.

It is noted that in some embodiments, AL database 400 may be combined with a server and CPU. In this case, steps 405, 435, and 460, which relay information from AL database 400 to AL server 410, are optional and may be excluded completely. In this case, vehicle value record 430 and credit record 455 may not be saved in AL database 400 and may exists as temporary data points that are deleted once the respective logic processes the data. In another embodiment vehicle value record 430 may not be saved until step 465. Credit record 455 may not be saved at all.

In another embodiment, system 10 is iterative. That is, if the loan offers provided by the system are not suitable, updated vehicle data 115 may be provided and the method may be run again until a suitable loan offer results.

Overall the system is able to use standards that are set by the lenders to structure a vehicle loan. These variables include the particular vehicle, age of the vehicle, and the mileage of the vehicle. It is noted that these variables are not exclusive. There are other variables that may be considered. These variables will determine the term and the rate of the loan. The system provides an affordability test, meaning that the system ensures that an individual buys an automobile that is within that individual's budget and is thus affordable to the individual.

In one embodiment, the method and system use a spreadsheet to input and receive information. In a preferred embodiment, the spreadsheet is an Excel spreadsheet. In another embodiment, the system includes twenty different variables for determining what the best lender and loan are for that particular consumer. In some instances, the variables are provided by the lenders.

The method and system of identifying automobile loans provides benefits to the automobile dealership and the consumer. It saves the dealership time by minimizing the number of inquiries. This aspect also benefits the consumer because his or her credit rating isn't impacted as much.

Lender Guidelines and Algorithm

As detailed above, an aggregate of lender data (or lender guidelines) 100 needs to be provided to AL database 400 and AL server 410. Lender data 100 is comprised of lender table 320 along with other information about the lender such as physical location and contact information. Lender table 320 includes customized lending tables 325. It is noted that there is at least one customized lending table 325 for each lender. This is in direct contrast with how most dealerships obtain loans for their customers. Previously, most dealerships and lenders use a single standardized lending table covering all lenders to obtain loans for their customers.

Some of the information and data included in the customized lending tables 325 is provided directly by the lenders to the dealership and some of the other information and data is derived from the analysis of primary consumer data of prior transactions. That is, the dealership will have a history of previous loans from a particular lender and the dealership can use this information in determining what that particular lender is looking for when offering an automobile loan. Together the direct data and the analyzed data provide the automobile dealership with the customized lending tables 325.

A computer-generated program saves results for future guidelines that the lenders do not disclose to dealerships. Capturing different categories of data that determine the habit of each lender is how the recorded data is used. Below are the determining factors that are considered in the lender guidelines described.
Payment to Income often referred to as PTI, is a measurement of risk in each financial institution.
Loan to Value is what is the collateral being purchased vs. the loan amount requested
Charge-off amount is what the consumer has on their credit profile as an aggregate amount owed to creditors that were not paid in full as agreed.
Trade-lines are lines of credit or debts in repayment from a financial institution.
Time since Bankruptcy
Time at the job

When a customer's data 112 or information is entered into the system 10, a pre-qualification will soft pull the customer's credit information 240. This will not impact the consumer's credit score but will provide the system 10 data or information to pair lender guidelines vs. collateral requested for purchase. Then the collateral requested for purchase is either entered manually 238 or pulled from the dealership inventory 235. The system 10 will first take the credit score 242 and record it for use in calculating the payment of the collateral requested. The system 10 will pull the score from Equifax®, Experian®, and Transunion®, FICO® reports 242.

The system 10 will then analyze the trade-lines, charge-off amounts, and time since bankruptcy to determine if the customer qualifies vs. the lender guidelines provided. Suppose the customer's data 112 or information meets the minimum or maximum of the category in the lender guidelines. Then the collateral (or vehicle) is analyzed to see if it meets the lender guidelines as well. It must meet maximum mileage and maximum loan to value requested. The collateral will also provide information to the correlated lender's rate table. This table will give the consumer payment based on the year's annual percentage rate and category based on consumer score.

Lending Institution Rate Table

The rate tables are based on lender guidelines of vehicle age and FICO® band-tiered groups. Some of these tables are provided by the lender, and some are derived from the results of the experience of customer approvals. The intention is not to have the lender deviate from the bias exception of one dealership over the other dealership. The result for a specific scenario will be captured and used to predictively model rate changes at each institution. The system 10 will record the consumer's FICO Score®, payment to income, loan to value, the model year of the collateral, and mileage.

Results Section

The results are then generated 245, 248 for the consumer as a payment option for the collateral (or vehicle) inputted for purchase. The result section will display up to 5 qualified lenders, filtered by lowest payment as the top result. The cost (monthly payment) is calculated by the equation below using the specific tax rate based on the consumer's exact address automatically populated by API integration.

$$c = \frac{r \times P}{1 - {( 1 + r )}^{- N}}$$

P=Sales price+trade equity (trade value−amount owed)+sales tax %−cash down

c=Monthly Payment

r=Monthly Interest Rate (in Decimal Form)=(Yearly Interest Rate/100)/12

P=Principal Amount on the Loan

N=Total # of Months for the loan (Years on the loan×12)

Example: Monthly payment for a five-year auto loan, with a principal of $25,000, and a yearly interest rate of 6.5%:

$$c = \frac{\text{.005416667} \times 25 , 000}{1 - {( 1 + \text{.005416667} )}^{- 60}}$$

r=(6.5/100)/12=0.005416667

P=25,000

N=(5×12)=60

The Monthly Payment is $489.15

Consumer and Sale Consultant View

The results page will also display the consumer's monthly payment and income needed to purchase the collateral. This is determined by taking the maximum payment to income established in the lender data 100 or lender guideline that the system 110 will calculate. This is analyzed by pulling the consumer's FICO® during soft pull pre-qualification 240, stored for 24 hours. Each lender data 100 or lender guideline has programmed this, and then the calculation is as follows.

Monthly payment/payment to income %=Income required

Dealership manager/Administrator View

The dealership will have the same result display as the consumer and sales consultant view, with additional fields showing the advantage of different lending institutions. The result will also show monthly payments and required income. In addition, this display will show what the lender will allow for its back-end policy. This is the policy of additional added products to protect the customer if they incur an issue while owning the vehicle. The options could include a vehicle service program, tire and wheel coverage, key replacement, paint-less dent repair, gap insurance, pre-paid maintenance, low jack, and allowable ranges. This view will also display the profit if the dealer is to mark up the interest rate from the lender. This view will also show the best contact for the credit and funding department. This section will also display any bonus programs or competitive advantages our underwriting programmers acknowledge.

System Algorithm

Once the consumer has entered information found on their license, the system will run a pre-qualification through a credit API 445. It will pull all 3 FICO® scores for each credit reporting agency. Then examine the total amount charged-off off credit from creditors. Then read how many revolving or trade-lines are on the report. The system 10 will refer to the lender data 100 or lender guidelines that the underwriting engineers program based on either lender-given data or prior lender approvals. The system 10 then reviews the remaining lenders that are programmed for each dealership. The score refers to the lender rate referenced before calculating a payment and then filtered by the lowest amount showing up to 5 lender results for each customer. The system 10 will show up to 5 conditional lenders. The condition is a 10% or less loan tolerance to value or payment to the customer's income. The system 10 will display the dollar amount needed to get to that pre-programmed tolerance in the lender guideline.

Pre-Qualification Database

The system will eliminate the need for paper credit request forms. The consumer will be able to sign with their finger or mouse acknowledging their soft credit request and privacy notice. The consumer data 112 (including loan details) will be saved in an offer database 330 for five years. The manager-level access will then be able to see when this occurred in order to continue quoting pre-qualified payments to eliminate a bias towards racial or sexual predeterminations.

Application Submission

The customer data 112 or information is fed it into an application to then submit to lenders on different integrated submission portals thru the dealership. The system 10 can send the application to one or up to 3 various dealership submission portals simultaneously, thus speeding the transactional time. The results 245, 248, from the lender are then captured and then filtered into the guidelines and rate tables for future usage for similar scenarios. If a document is missing for the lender while the contract is in funding, it can be uploaded through the system 10. This will allow a consumer to view what is needed to finalize financing. This will enable the consumer to apply for a vehicle loan to multiple lenders through a dealership system 10 without any interaction from the dealership. It will also allow for awareness of when their loan is being processed.

### EXAMPLES

### Example 1

In one illustrative embodiment, the first step is disclosed, wherein the first step is inputting customer data including name and address. Step two requires inputting the vehicle information including the make and model of the automobile to be financed, along with mileage, vehicle value, the loan amount and term request. Step 3 provides feedback to the automobile dealership including information on suitable lenders for the consumer and vehicle and loan amount and term. As can be seen, the method and system will provide information about the location of the lender, the selected vehicle value and mileage, the total loan value and term, the monthly payment, the consumer's income. credit condition, trade lines, the consumer's credit score, and time since bankruptcy and time at current job. Finally, step 4 provides a list of lenders, the lenders back end limit, and any special programs that lender has available. The back end ratio is a ratio that indicates what portion of a person's monthly income goes toward paying debts. With this information, the automobile dealership can then apply for a loan that mosts suits the consumer given the vehicle and that person's particular economic circumstances at the time of purchasing the vehicle.

It will be appreciated by those skilled in the art that while the method and system for identifying automobile loans has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

What is claimed is:

1. A computer-generated method comprising:
receiving, by a database, user input that includes customer data and vehicle data from a device, wherein the database includes lender data including at least one customized lending table for each lender;
responsive to receiving vehicle data from the database, a server initiates vehicle logic to request vehicle value from an auto API;
generating, by the server, in a database a record of the vehicle value;
responsive to receiving customer data from the database, the server initiates credit logic to request credit information from a credit API;
generating, by the server, in a database a record of the credit information;
responsive to receiving lender data, vehicle value, and credit information from the database, the server initiates offer logic to generate loan offers;
generating, by the server, in a database a record of loan offers, the record comprising data containing APR and monthly payment of the automobile loan offer, the database comprising non-transitory machine-readable storage media storing one or more records of one or more automobile loan offers; and
presenting, by the server or database, for display on the device the record of loan offers.

2. The method of claim 1 wherein the database contains the server.

3. A computer-generated method comprising:
receiving, by a database, user input that includes customer data and vehicle data from a device, wherein the database includes lender data including at least one customized lending table for each lender;
responsive to receiving vehicle data from the database, a server initiates vehicle logic to request vehicle value from an auto API;
generating, by the server, in a database a record of the vehicle value;
responsive to receiving lender data, vehicle value, and credit information from the database, the server initiates offer logic to generate loan offers;
generating, by the server, in a database a record of qualified loan offers, the record comprising data containing APR and monthly payment of the automobile loan offer, the database comprising non-transitory machine-readable storage media storing one or more records of one or more automobile loan offers; and
presenting, by the server or database, for display on the device the record of qualified loan offers.

4. The method of claim 7 further including:
responsive to receiving customer data and qualified loan offers from the database, the server initiates credit logic to request credit information from a credit API;
generating, by the server, in a database a record of the credit information;
responsive to receiving lender data from the database, the server initiates offer logic to generate loan offers;
generating, by the server, in a database a record of loan offers, the record comprising data containing APR and monthly payment of the automobile loan offer, the database comprising non-transitory machine-readable storage media storing one or more records of one or more automobile loan offers; and
presenting, by the server or database, for display on the device the record of loan offers.

5. The method of claim 3 wherein the database contains the server.

6. A computer-generated method comprising:
receiving, by a database, user input that includes customer data and vehicle data from a device, wherein the database includes lender data including at least one customized lending table for each lender;
responsive to receiving vehicle data from the database, a server initiates vehicle logic to request vehicle value from an auto API;
generating, by the server, a data point that includes the vehicle value;
responsive to receiving customer data from the database, the server initiates credit logic to request credit information from a credit API;
generating, by the server, a data point that includes credit information or pre-qualification information;
responsive to receiving lender data from the database, the server initiates offer logic to generate loan offers;
generating, by the server, in a database a record of loan offers, the record comprising data containing APR and monthly payment of the automobile loan offer, the database comprising non-transitory machine-readable storage media storing one or more records of one or more automobile loan offers; and
presenting, by the server or database, for display on the device.

7. The method of claim 6 wherein the database contains the server.
